(19) United States
(12) Patent Application Publication
(10) Pub. No.: US 2026/0129087 A1
(43) Pub. Date: May 7, 2026

(54) RESOURCE RECRUITMENT SYSTEM

(71) Applicant: The Toronto-Dominion Bank, Toronto (CA)

(72) Inventors: Jonathan Joseph PRENDERGAST, West Chester, PA (US); Barry Wayne BAIRD, JR., Kennett Square, PA (US)

(73) Assignee: The Toronto-Dominion Bank, Toronto (CA)

(21) Appl. No.: 18/934,306

(22) Filed: Nov. 1, 2024

(51) Int. Cl. H04L 67/04; G06F 3/0488; G06F 9/50

(52) U.S. Cl. CPC H04L 67/04; G06F 3/0488; G06F 9/505

(57) ABSTRACT

A processor-implemented method and system are described. The method may include: providing, at a computing system associated with a resource domain, a resource consumption event management interface, the resource consumption event management interface including a first resource consumption event indicator associated with a first resource consumption event at the resource domain; detecting a touch gesture of a defined type applied to the first resource consumption event indicator; and in response to detecting the touch gesture of the defined type applied to the first resource consumption event indicator, recruiting a supplemental resource, based on a resource consumed during the first resource consumption event, to make the supplemental resource available to the resource domain.

### TECHNICAL FIELD

The present application relates to resource consumption management systems and, more particularly, to methods and systems for recruiting a supplemental resource using a defined gesture.

### BACKGROUND

In computing systems, resource consumption events sometimes occur, causing resources to be consumed. By way of example, such resource consumption events may consume processor cycles, memory and/or network resources, or other types of resources. Some such resource consumption events may cause a temporary drain in resources.

It is often useful or desirable to manage resource consumption events and resource usage. It may, however, be difficult to do so on computing systems that have limited capabilities. For example, managing resource consumption events may be difficult on mobile computing devices or tablet-style computing devices, which may suffer from limited computing capabilities, including limited screen area.

Often, it is necessary to manage such resource consumption events quickly to avoid compounding problems that occur due to resource-constraints that arise from such resource consumption events.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 shows a flowchart showing operations performed by a computing system in recruiting a supplemental resource;

FIG. 6 shows a flowchart showing operations performed by a computing system in recruiting a supplemental resource;

FIG. 7 shows a flowchart showing operations performed by a computing system in recruiting a supplemental resource;

FIG. 8 is an example resource consumption event management interface;

FIG. 9 is an example resource consumption event management interface;

FIG. 10 is an example resource consumption event management interface;

FIG. 11 is an example resource consumption event management interface;

FIG. 12 is an example resource consumption event management interface;

FIG. 13 is an example is an example resource consumption event management interface; and

FIG. 14 is an example resource consumption event management interface.

Like reference numerals are used in the drawings to denote like elements and features.

### DETAILED DESCRIPTION OF VARIOUS EMBODIMENTS

In accordance with one aspect of the present invention, there is provided a computer system. The computer system may include a processor. The computer system may include a communications module coupled to the processor. The computer system may include a memory coupled to the processor. The memory may store instructions that, when executed, configure the processor to: provide, at a computing system associated with a resource domain, a resource consumption event management interface, the resource consumption event management interface including a first resource consumption event indicator associated with a first resource consumption event at the resource domain; detect a touch gesture of a defined type applied to the first resource consumption event indicator; and in response to detecting the touch gesture of the defined type applied to the first resource consumption event indicator, recruit a supplemental resource, based on a resource consumed during the first resource consumption event, to make the supplemental resource available to the resource domain.

In yet another aspect, a processor-implemented method is described. The processor-implemented method may include: providing, at a computing system associated with a resource domain, a resource consumption event management interface, the resource consumption event management interface including a first resource consumption event indicator associated with a first resource consumption event at the resource domain; detecting a touch gesture of a defined type applied to the first resource consumption event indicator; and in response to detecting the touch gesture of the defined type applied to the first resource consumption event indicator, recruiting a supplemental resource, based on a resource consumed during the first resource consumption event, to make the supplemental resource available to the resource domain.

In some implementations, the first resource consumption event may be a computing event that uses, consumes, transfers or temporarily occupies one or more of the following types of resources: processor cycles, memory and network resources.

In some implementations, recruiting the supplemental resource includes performing one or more of: releasing memory reserves; freeing up network resources using network management techniques; performing a database operation to reflect an adjustment of an amount of resources available in the resource domain; and performing a transfer of the supplemental resource.

In some implementations, the resource domain may include one or more of a particular computer system, a particular computing network, and a particular logical storage area.

In some implementations, the instructions may further configure the processor to: during the touch gesture, displaying indicators associated with one or more post-processing action options; and detect that the touch gesture includes a drop at one of the indicators associated with one of the post-processing action options. Recruiting the supplemental resource may include recruiting the supplemental resource based on the post-processing action option associated with the one of the indicators associated with the drop.

In some implementations, the one or more post-processing action options may be selected based on a data type associated with the first resource consumption event.

In some implementations, providing, at the computing system associated with the resource domain, the resource consumption event management interface may include: determining that the first resource consumption event satisfies defined criteria; and in response to determining that the first resource consumption event satisfies the defined criteria, triggering a notification at the computing system associated with the resource domain, the notification facilitating access to the resource consumption event management interface.

In some implementations, determining that the first resource consumption event satisfies defined criteria may include determining that the first resource consumption event is an outlier event.

In some implementations, determining that the first resource consumption event satisfies defined criteria may include determining that the first resource consumption event consumed at least a threshold amount of resources.

In some implementations, the resource consumption event management interface may further include a second resource consumption event indicator associated with a second resource consumption event at the resource domain. The resource consumption event management interface may further include a visual feature to indicate which of the first and second resource consumption events are eligible for supplemental resource requests.

In some implementations, the instructions may further configure the processor to, after recruiting the supplemental resource, update the resource consumption event management interface to visually indicate that the supplemental resource has been recruited.

In some implementations, the touch gesture of the defined type may be a lateral swipe gesture.

In accordance with another aspect of the present invention, there is provided a non-transitory computer-readable storage medium storing instructions that when executed by a processor of a computing system cause the computing system to perform a method described herein. In one example, the computer-readable storage medium may store instructions that, when executed by a computing system, cause the computing system to: provide, at a computing system associated with a resource domain, a resource consumption event management interface, the resource consumption event management interface including a first resource consumption event indicator associated with a first resource consumption event at the resource domain; detect a touch gesture of a defined type applied to the first resource consumption event indicator; and in response to detecting the touch gesture of the defined type applied to the first resource consumption event indicator, recruit a supplemental resource, based on a resource consumed during the first resource consumption event, to make the supplemental resource available to the resource domain.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

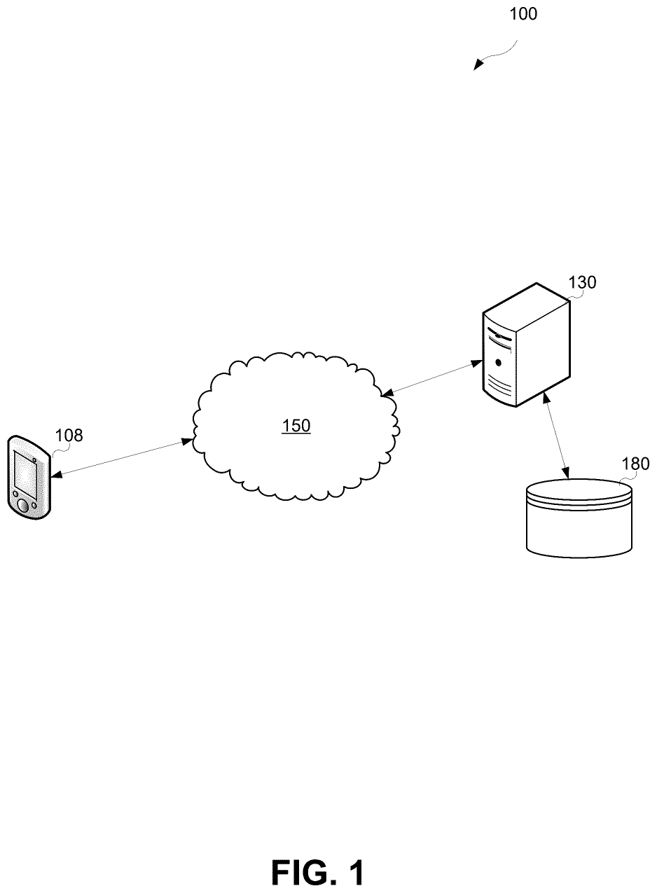

FIG. 1 is a block diagram illustrating an operating environment of an example embodiment. Various components cooperate to provide a system 100 which may be used, for example, to perform an operation. As shown, the system 100 may include a first device 108. The first device 108 may be associated with a first resource domain. The first device 108 is a computing device.

The first resource domain may be a logical and/or physical resource domain. The resource domain may be a domain at which a finite amount of resources are available at any given time. The first resource domain may be a first logical storage area or may be associated with a first logical storage area, such as an account. A resource domain may be a physical or virtual location at which a resource is stored, represented, or made available. By way of example, the resource domain may be an account, device or system to which certain computing resources are made available. By way of example, the computing resources may be or may include processor cycles, memory and/or network resources. The resources may take other forms in other implementations. By way of example, resources that are associated with a resource domain may be or may represent tokens, digital assets, data, database assets, cryptocurrencies, value indicators, bandwidth, documents, images, photographs, streaming video, streaming audio, or other resources. In some implementations, a resource domain may be an account and/or logical storage area and/or a record in a database or may be associated with an account and/or a logical storage area and/or a record in a database. For example, the resource domain may be a demand deposit account (DDA) or may be associated with a demand deposit account (DDA).

In some implementations, the first resource domain may exist on the first device 108. In other implementations, the first resource domain may be a domain that exists outside of the first device 108. That is, it may instead be a domain that exists on or is represented on another system apart from the first device 108. For example, the first resource domain may be associated with computing resources on another system. For example, it may be that the first device 108 is used as a client device for managing resources that are stored, located or, or represented by another resource domain system 130. An example of such a resource domain system 130 is illustrated in FIG. 1.

The resource domain system 130 may store, define, provide and/or represent one or more resources. In some implementations, at least some such resources may be associated with a particular resource domain. The particular resource domain may be a particular account and/or a logical storage area and/or a record in a database and/or device. For example, in some implementations, the resource domain system 130 may be a database management system. The database management system may associate different resources with different resource domains. For example, a given resource may be associated with a particular account and/or logical storage area and/or record in a database and/or device. By way of example, the resources in one resource domain that is represented at the resource domain system 130 may be associated with the first device 108. This may allow the first device 108 to access such associated resources. By way of example, where the resources are computing resources, the first device 108 may be permitted to use such computing resources. In some implementations, the first device 108 may be permitted to manage or control the associated resources. By way of example, the first device 108 may initiate transfer of such resources to other resource domains, may review and/or display historical data such as one or more past resource consumption events, may control access to the resources in the associated resource domain (e.g., permitting other devices apart from the first device 108 to access such resources) or may perform other management functions.

The first device 108 and the resource domain system 130 may be coupled to one another through a network 150. The network 150 may include a public network, such as the Internet, and/or a private network.

The first device 108 may be a computing device that may be associated with an object. The object may be or include an entity, such as a person or business. The object may be or include a system, such as a server or other type of computing system. The object may be referred to as an account holder or a logical storage area holder, in some implementations. The first device 108 may be associated with an object that is also associated with the first resource domain. The first resource domain may be an account or other storage area at one of the resource domain system 130.

In one example, the object may be associated with a mobile connectivity account. That is, the first resource domain may be a mobile connectivity account. The mobile connectivity account may receive a periodic replenishment of resources. For example, the mobile connectivity account may receive, from a mobile services system, a periodic replenishment of a data allocation or some other allocation. By way of example, the mobile connectivity account may have a monthly data allocation. The data allocation may enable the first device 108 to send and receive data. By way of example, the data allocation may be a wireless data allocation. The data allocation may be reflected by a balance and, when the balance falls to zero, no more data may be used until the balance is increased above zero. The data allocation may be specified in data units such as, for example, megabytes, gigabytes, etc.

In another example, the first resource domain may be a computing resource account or may represent a computing resource account. The computing resource account may track computing resources that are to be made available to a particular object, such as a particular entity or computing system. The computing resources may be or may include, for example, processor cycles, memory, network resources, server resources, hosting resources, or computing resources of another type. The computing resource account may receive, from a computing resource providing system, a periodic replenishment of a computing resource allocation. The computing resource allocation may, for example, enable the first device 108 to use an associated computing resource at a server or other system. The computing resource allocation may be reflected by a balance and, when the balance falls to zero, no more computing resources may be used (e.g., by the first device 108) until the balance is increased above zero. By way of example, it may be that the computing resource account is periodically allocated resource units reflecting an amount of server time, processor cycles, memory, network bandwidth, or another computing resource that are available to an object associated with the computing resource account.

In yet another example, the first resource domain may be or may represent a streaming service account. The streaming service account may track streaming resources that are to be made available to a particular object, such as a particular entity or computing system (such as the first device 108), by a streaming system. The streaming services may be associated with any one or both of streaming video (e.g., movies, television episodes, and/or clips) and streaming audio (e.g., songs and/or podcasts). A streaming service may periodically allocate streaming resources to the streaming service account. Such an allocation may be made by updating a balance associated with the account. The balance may reflect an amount of resource units available to the account. The resource units may represent, for example, a number of time units, such as minutes, a number of media units, such as a number of episodes, songs, podcasts, movies, etc., or a number of data units such as a number of bytes, megabytes or gigabytes. When the balance falls to zero, no more streaming resources may be used in association with the streaming service account until the balance is increased above zero.

In yet another example, the first resource domain may be or may represent a demand deposit (DDA) account, such as a bank account. A balance may indicate an amount of resources held in the account and, when the balance falls to zero, operations that requires the use of resources, such as transfer operations, may not be performed using the bank account.

The resource domain system 130 may include or may be connected with a first database 180. One of the resource domains maintained by or accessible from the resource domain system 130 may be stored on or represented in the first database 180.

The first device 108 may take a variety of forms such as a smartphone, a tablet computer, a wearable computer such as a head-mounted display or smartwatch, a laptop or desktop computer, or a computing device of another type. The first resource domain system may be referred to as a first computing device and/or first computing system and may also be referred to as a first server. The first device 108 may be referred to as one or more of a client device, an electronic device, a computing device and a computing system.

The network 150 is a computer network. In some embodiments, the network 150 may be an internetwork such as may be formed of one or more interconnected computer networks. For example, the network 150 may be or may include an Ethernet network, an asynchronous transfer mode (ATM) network, a wireless network, a telecommunications network, or the like.

The first resource domain system 130 may be configured to communicate with other servers, such as a second resource domain system using one or more communication protocols, which may also be referred to as transfer protocols or transfer rails. Resources may be transferred from one resource domain to another and at least some such transfers may occur across resource domain systems.

The first device 108 and the first resource domain system 130 may be in geographically disparate locations. Put differently, the first device 108 and the first resource domain system 130 may be remote from one another. Two or more of the first device 108 and the resource domain system 130 may communicate via the network 150.

The first database 180 may store account data. That is, the first database 180 may store data that is associated with various accounts. In at least some implementations, each record/logical storage area in the first database 180 may be associated with a particular one of these accounts.

The first resource domain system 130 is a computing system and may be referred to, for example, as a first computing system.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components.

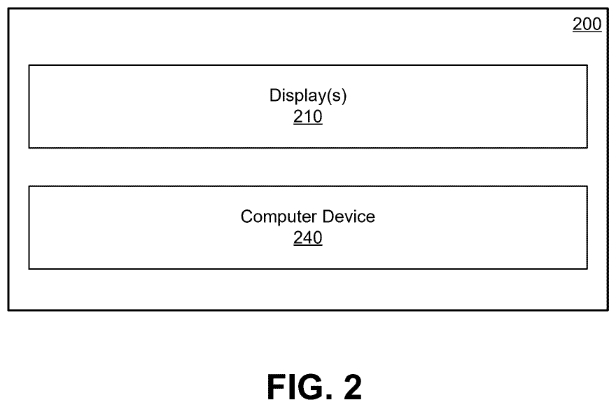

FIG. 2 is a simplified schematic diagram showing components of an exemplary computing device 200. The computing device 200 may include modules including, as illustrated, for example, one or more displays 210 and a computer device 240. Modules may include hardware and/or software, such as drivers. The computing device 200 may be or may include one of the systems of FIG. 1. For example, in some implementations, the computing device 200 may operate as the first device 108. Another computing device 200 may operate as the resource domain system 130.

The one or more displays 210 may be or include a display module and/or a display interface. The one or more displays 210 are used to display screens of a graphical user interface that may be used, for example, to communicate with the first resource domain system 130 (FIG. 1). The one or more displays 210 may be internal displays of the computing device 200 (e.g., disposed within a body of the computing device) or external displays. The displays have limited screen area.

The computer device 240 is in communication with the one or more displays 210. The computer device 240 may be or may include a processor which is coupled to the one or more displays 210.

The computing device 200 may include one or more input devices, which may be in communication with the computer device 240. The input devices may take various forms, including, for example, any one or more of: a sensor, a button, a keyboard, a pointing device, a touchscreen, a camera, a microphone, or an input device of another type. In some instances, the input device may be integrated with the display 210. For example, the display 210 may be a touchscreen display which includes a touch-sensitive surface. The touchscreen display may use any touch-sensing technology including, for example, capacitive sensing, optical sensing and/or resistive sensing.

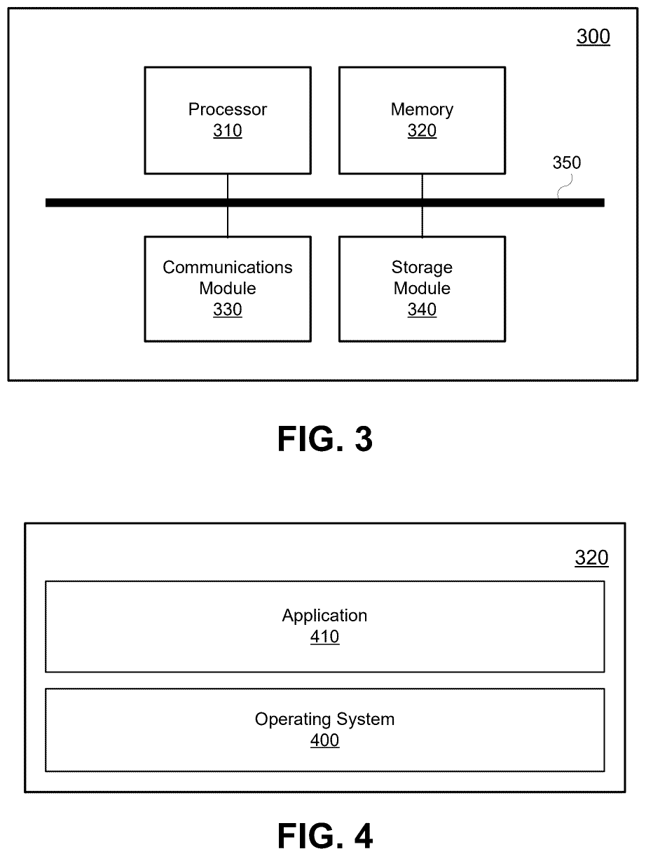

Referring now to FIG. 3, a high-level operation diagram of an example computer device 300 is shown. In some embodiments, the computer device 300 may be exemplary of the computer device 240 (FIG. 2), the first resource domain system 130 and/or first device 108.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive, or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application. The communication module may, in at least some implementations, be referred to as one or more of: communication hardware, a communication chip, a network connection device, a communication device, a communication interface.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store and/or a memory and/or a computer memory.

Where the example computer device 300 functions as the first resource domain system 130 of FIG. 1, the storage module 340 may allow the example computer device 300 to access the secure data in the first database 180.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2), the first device 108 and/or the first resource domain system 130.

While a single application 410 is illustrated in FIG. 3, in operation the memory 320 may include more than one application 410 and different applications 410 may perform different operations. For example, in at least some embodiments in which the computer device 300 is functioning as the first device 108, the applications 410 may include an application that provides a resource consumption event management interface. For example, the resource consumption event management interface may be provided in a resource management application. The resource management application may be configured for communications with the first resource domain system 130. In at least some implementations, the resource management application may be configured for secure communications with the first resource domain system 130.

In some implementations, the resource management application may provide various functions such as, for example, the ability to display data associated with a resource domain. By way of example, the resource management application may be configured to display to display a resource consumption event management interface. This interface may list one or more resource consumption events. For example, this interface may include one or more resource consumption event indicators associated with respective resource consumption events at a particular resource domain. The resource consumption events are events that use, consume, transfer and/or temporarily occupy resources, such that the associated resources are temporarily or permanently unavailable. The resource consumption events may be associated with descriptor and the descriptor may be displayed in the associated resource consumption event indicator. This descriptor may be, for example, a description or a task, process or transfer that used, consumed, transferred, or temporarily occupied the resource. By way of example, descriptor may be a process identifier, such as a name of a computing process that has made use of a resource. By way of further example, the descriptor may be a recipient identifier, such as a name or account identifier associated with a recipient of a transfer made using the resource. Other descriptors are possible apart from those explicitly listed herein.

The resource consumption event indicators may indicate other data instead of or in addition to the descriptor. By way of example, the resource consumption event indicators may indicate an amount of resources used, consumed, transferred and/or temporarily occupied through in a given event. This may be referred to as a resource quantum indicator. The resource quantum indicator may be displayed in association with a descriptor for the given event. By way of example, the resource quantum indicator may be displayed adjacent to the descriptor for the event. In at least some implementations, the resource consumption event indicator for a given event may also display a type indicator. The type indicator may indicate a type of resources consumed. By way of example, the type may include, for example, processor cycles, megabytes, gigabytes, units of value such as coins or dollar, etc.

By way of further example, the resource consumption event indicators may include a temporal indicator. The temporal indicator may indicate a time associated with the resource consumption event. The time may be indicated as a relative time (e.g., relative to the current time) or an absolute time (e.g., such as a calendar date and/or a clock time associated with a particular time zone). The time may be a time when the resource consumption event started and/or a time when the resource consumption event concluded.

The resource consumption event management interface may display a plurality of resource consumption event indicators, each associated with a different resource consumption event. By way of example, the resource consumption event management interface may display a first resource consumption event indicator associated with a first resource consumption event and a second resource consumption event indicator associated with a second resource consumption event.

In some implementations, the resource consumption event management interface may display current resource consumption events. For example, the resource consumption event management interface may display resource consumption events that are being conducted at a present time. For example, any ongoing resource consumption events that are continuing to consume resources may be listed in the interface.

In some implementations, the resource consumption event management interface may display a listing of resource consumption events that occurred over a time period. The time period may be, for example, a day, a week, a month, a year, etc. The time period may be a default time period, or it may be a time period defined by a user via the resource consumption event management interface.

In some implementations, the resource consumption event management interface may be a filtered list. For example, it may be filtered to only display events associated with resources of a particular type. By way of example, the resource consumption event management interface may be filtered to display only events associated with a particular type of resource or set of resource types. For example, it may be that the resource consumption event management interface displays resource consumption events consuming random access memory (RAM).

By way of further example, the resource consumption event management interface may be filtered to display only events that use, consume, transfer and/or temporarily occupy at least a threshold amount of resources. The threshold may be a default threshold or it may be user-defined.

By way of further example, the resource consumption event management interface may be filtered to display only events having a descriptor satisfying defined criteria. That is, the events may be filtered based on the descriptor. Such filtering may either identify or exclude events based on descriptor matching with defined string. The string may be a default string or may be user-defined.

The resource consumption event management interface may include only resource consumption events associated with a particular resource domain.

By way of further example, in at least some embodiments in which the computer device 300 functions as the first device 108, the applications 410 may include a web browser, which may also be referred to as an Internet browser. In at least some such embodiments, the first resource domain system 130 may be or may include a web server that may serve one or more of the interfaces described herein. The web server may cooperate with the web browser and may serve as an interface when the interface is requested through the web browser. By way of example, the resource consumption event management interface may be displayed in a web browser.

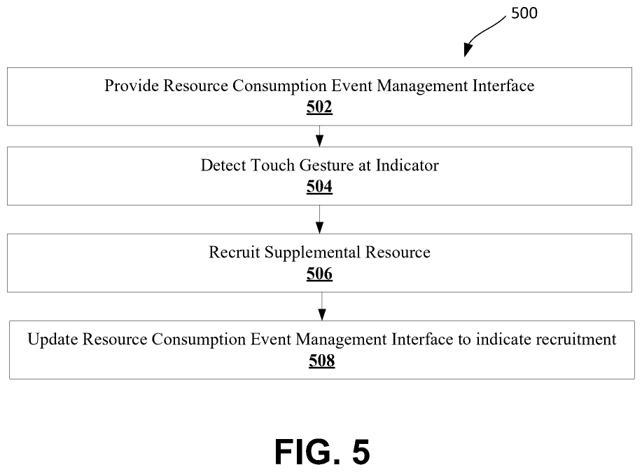

Reference is now made to FIG. 5, which shows, in flowchart form, an example method 500 of managing resources at a resource domain. The method 500 may be implemented by a computing system, such as the first resource domain system 130 and/or the first device 108 of FIG. 1. For example, a software module may be configured to cause the first resource domain system 130 and/or the first device 108 of FIG. 1 to implement the method 500. The method 500 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first resource domain system 130 to perform all or parts of the method 500 or a portion thereof.

In performing the method 500, the first resource domain system 130, or the first device 108 may cooperate with other systems and devices such as, for example, the other of the first device 108 (FIG. 1) and the first resource domain system 130. Each of these devices may be configured with processor-executable instructions which cause such devices to perform methods which cooperate with the method 500. Accordingly, operations that are referred to below as being performed by the first device 108 may be included in a method which a processor of the first device 108 may perform. Similarly, operations that are referred to below as being performed by the first resource domain system 130 may be included in a method which a processor of the first resource domain system 130 may perform. Further, in performing such a method, the first resource domain system 130 may cooperate with the first device 108. Further, at least some operations described as being performed by the first device 108 or the first resource domain system 130 may be performed by another device or system. For example, some of the operations described as being performed by the first resource domain system 130 may instead be performed by the first device 108 and vice versa.

At an operation 502, the first resource domain system 130 may provide, at a computing system associated with a resource domain, a resource consumption event management interface. The computing system associated with the resource domain may be the first device 108. Accordingly, the operation 502 may be performed by one or both of the first resource domain system 130 and the first device 108. The first device 108 may be associated with a particular resource domain. For example, memory that is accessible to the first resource domain system 130 may associate a particular resource domain with a particular device. In some implementations, this association may be made using one or both of a token or a credential. By way of example, first resource domain system 130 may store credentials that are associated with a particular resource domain, such as the first resource domain, and the first device 108 may provide the credentials associated with the particular resource domain to the first resource domain system 130 to enable the first resource domain system 130 to validate the first device 108 as being associated with the first resource domain. The credentials may be or include a unique identifier, such as a username, account number, account identifier, etc. The credentials may be or include a secret code, such as a password or PIN.

In some implementations, the validation of the first device 108 may rely on a token. By way of example, the first resource domain system 130 may issue an access token to the first device 108 and the access token may be associated with the first resource domain. The first device 108 may use the access token to demonstrate, to the first resource domain system 130, that it is associated with the first resource domain. For example, the first device 108 may provide the token to the first resource domain system 130 and the first resource domain system 130 may verify that the token is associated with the first resource domain.

The resource consumption event management interface may, in at least some implementations, be provided in an application 410 (FIG. 4), such as a web browser or a special-purpose application, such as a resource management application.

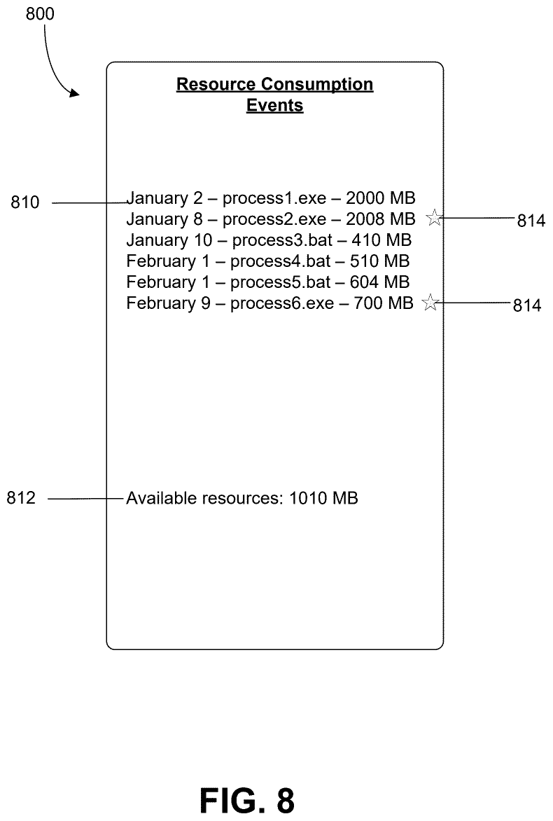

The resource consumption event management interface may include one or more resource consumption event indicators. For example, the resource consumption event management interface may include a first resource consumption event indicator. The first resource consumption event indicator may be associated with a first resource consumption event at the resource domain. Example resource consumption event management interfaces are illustrated in FIGS. 8 to 14.

Referring briefly to FIG. 8, an example resource consumption event management interface 800 is illustrated. The example resource consumption event management interface 800 may be displayed at the first device 108 at the operation 502 of the method 500 of FIG. 5. In this example, the resource consumption event management interface 800 includes one or more resource consumption event indicators 810 for resource consumption events that use, consume, transfer, or temporarily occupy memory resources. By way of example, the illustrated resource consumption event management interface 800 includes resource consumption event indicators 810 for a plurality of resource consumption events. For example, a first resource consumption event indicator may be associated with a first resource consumption event and a second resource consumption event indicator may be associated with a second resource consumption event. The first and second resource consumption events may be consumption events occurring at a common resource domain and this resource domain may be referred to as the first resource domain.

The memory resources may be, for example, random access memory (RAM), or it may be more permanent storage. In this example, the resource consumption event indicators 810 each include a descriptor, a temporal indicator, and a quantum indicator. The descriptor, in the example, indicates the name of a computing operation that used, consumed, transferred, or temporarily occupied the resources. The temporal indicator indicates a date when the resources were used, consumed, transferred, or temporarily occupied. The quantum indicator indicates an amount of resources used, consumed, transferred, or temporarily occupied. In the illustrated example, the quantum is expressed in terms of a number of megabytes, though other measures are possible. The example resource consumption event management interface 800 also includes an available resource indicator 812 which indicates a quantum of available resources following the various resource consumption events.

In the illustrated example, the example resource consumption event management interface 800 includes a plurality of resource consumption event indicators 810 for a plurality of resource consumption events. In some implementations, the resource consumption event management interface 800 may display only a single resource consumption event indicator 810 for a single resource consumption event.

As illustrated in FIG. 8, the resource consumption event management interface 800 may include a visual feature 814 to indicate which of the resource consumption events are eligible for supplemental resource requests. For example, only some of the resource consumption events may be eligible for supplemental resource requests. Others of the resource consumption events may not be eligible for supplemental resource requests. The visual feature 814 may indicate eligibility for supplemental resource requests. Eligibility may be determined based on various criteria. For example, it may be that a threshold is used to determine eligibility. For example, it may be that at least a threshold amount of resources must have been used, consumed, transferred, or temporarily occupied during a resource consumption event for that resource consumption event to be eligible for supplemental resource recruitment.

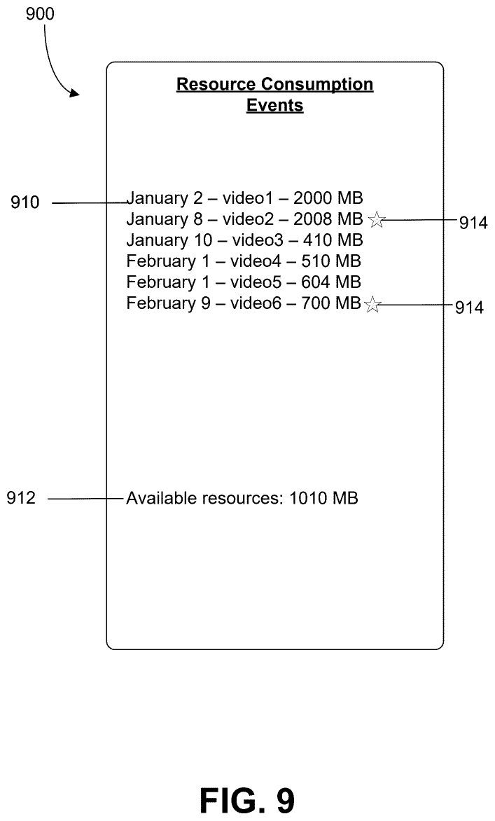

Referring now to FIG. 9, a further example resource consumption event management interface 900 is illustrated. The example resource consumption event management interface 900 may be displayed at the first device 108 at the operation 502 of the method 500 of FIG. 5. In this example, the resource consumption event management interface 900 includes one or more resource consumption event indicators 910 for resource consumption events that are associated with streaming and/or video consumption. Put differently, the resource consumption events that are represented in the resource consumption event management interface 900 may use, consume, transfer and/or stream data representing a video. In this example, the resource consumption event indicators 910 each include a descriptor, a temporal indicator, and a quantum indicator. The descriptor, in the example, indicates the name of a video that was streamed, used, transferred and/or consumed. The temporal indicator indicates a date when the resources were used, consumed, transferred, or temporarily occupied. The quantum indicator indicates an amount of resources used, consumed, transferred, or temporarily occupied. In the illustrated example, the quantum is expressed in terms of a number of megabytes, though other measures are possible. The quantum may be, for example, a size of the video. The example resource consumption event management interface 900 also includes an available resource indicator 912 which indicates a quantum of available resources following the various resource consumption events.

In the illustrated example, the example resource consumption event management interface 900 includes a plurality of resource consumption event indicators 910 for a plurality of resource consumption events. In some implementations, the resource consumption event management interface 900 may display only a single resource consumption event indicator 910 for a single resource consumption event.

Similar to the resource consumption event management interface 800 of FIG. 8, the the resource consumption event management interface 900 of FIG. 9 may include a visual feature 914 to indicate which of the resource consumption events are eligible for supplemental resource requests. Eligibility may be determined based on various criteria including, for example, a quantum of resources used and/or the descriptor or other metadata associated with a resource consumption event.

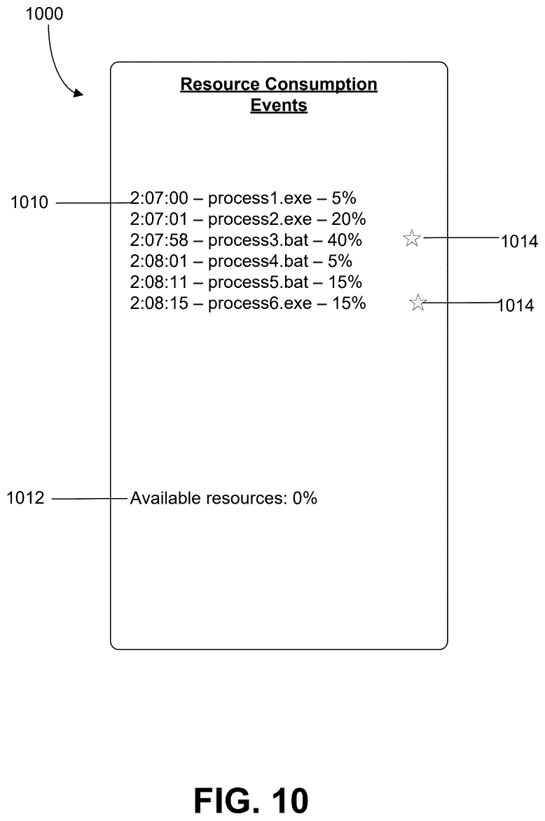

Referring now to FIG. 10, a further example resource consumption event management interface 1000 is illustrated. The example resource consumption event management interface 1000 may be displayed at the first device 108 at the operation 502 of the method 500 of FIG. 5. In this example, the resource consumption event management interface 1000 includes one or more resource consumption event indicators 1010 for resource consumption events that use, consume, transfer and/or temporarily occupy processing resources. For example, the resource consumption events may represent computing processes, computing operations or computing tasks. The resource consumption events may be events that use, consume, transfer and/or temporarily occupy processor cycles. In this example, the resource consumption event indicators 1010 each include a descriptor, a temporal indicator, and a quantum indicator. The descriptor, in the example, identifies a process that used, transferred and/or consumed processing resources, such as processing cycles. The temporal indicator indicates a date when the resources were used, consumed, transferred, or temporarily occupied. The quantum indicator indicates an amount of resources used, consumed, transferred, or temporarily occupied. In the illustrated example, the quantum is expressed in terms of a percentage. The percentage may be a percentage of a total available amount of resources. That is, the quantum in this example illustrates a relative amount of resources used, consumed, transferred, or temporarily occupied. The quantum could, however, be expressed in other ways. For example, the quantum may be an absolute amount of resources used, consumed, transferred or temporarily occupied in some implementations.

The example resource consumption event management interface 1000 also includes an available resource indicator 1012 which indicates a quantum of available resources following the various resource consumption events. In the illustrated example, the quantum of available resources is expressed in relative terms, though it may be expressed in absolute terms in other implementations.

In the illustrated example, the example resource consumption event management interface 1000 includes a plurality of resource consumption event indicators 910 for a plurality of resource consumption events. In some implementations, the resource consumption event management interface 1000 may display only a single resource consumption event indicator 1010 for a single resource consumption event.

Similar to the resource consumption event management interface 800 of FIG. 8, the resource consumption event management interface 1000 of FIG. 10 may include a visual feature 1014 to indicate which of the resource consumption events are eligible for supplemental resource requests. Eligibility may be determined based on various criteria including, for example, a quantum of resources used and/or the descriptor or other metadata associated with a resource consumption event.

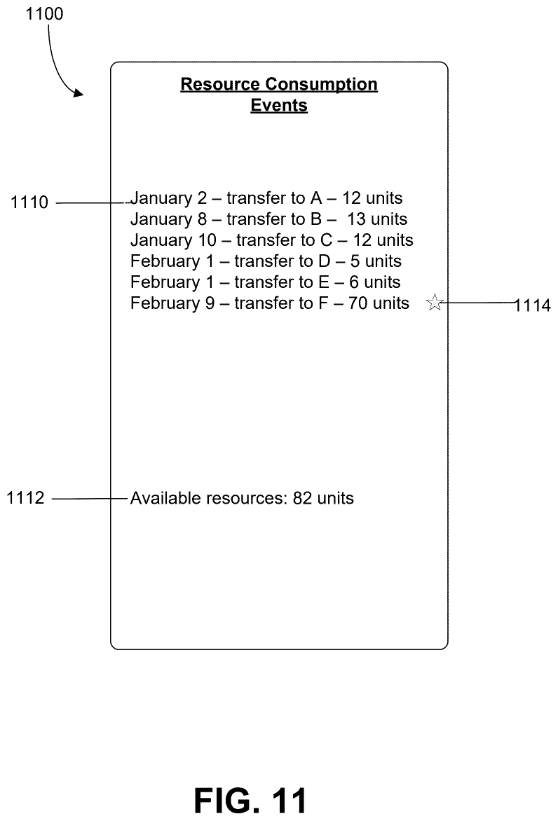

Referring now to FIG. 11, a further example resource consumption event management interface 1100 is illustrated. The example resource consumption event management interface 1100 may be displayed at the first device 108 at the operation 502 of the method 500 of FIG. 5. In this example, the resource consumption event management interface 1100 includes one or more resource consumption event indicators 1110 for resource consumption events that transfer resources. The transferred resources may be or include data. The transferred resources may be or include digital assets. For example, the transferred resources may include one or more of the following: numerical resources, multimedia resources, document resources, cryptocurrency resources, non-fungible resources such as non-fungible tokens (NFTs), fiat resources, value resources, tokens, or resources of other types. In some implementations, the resources may be database resources. That is, the resources may be resources that are stored in or represented in a database. In some implementations, the resources may represent resources stored in a DDA account. By way of example, in some implementations, the resource consumption events may be transfers of a resource out of a particular account such that the resource is no longer available to the particular account because it is, instead, available to another account. That is, each transfer may move a resource from one account to another. In at least some implementations, the resource consumption event indicators 1110 may be a transfer history and/or a transaction history.

In the example of FIG. 11, the resource consumption event indicators 1110 each include a descriptor, a temporal indicator, and a quantum indicator. The descriptor, in the example, identifies a transfer. In this instance, it identifies the transfer by identifying a destination associated with the transfer. The destination may be indicated using an identifier associated with a recipient account for the transfer. By way of example, identifier may be a name or number associated with the recipient account.

The temporal indicator indicates a date when the transfer occurred. In the illustrated example, the date is a calendar date, though the date may include a time in some implementations instead of or in addition to the calendar date.

The quantum indicator indicates an amount of resources transferred. In the illustrated example, the quantum indicator is a numerical indicator expressed in units. The units may be of a particular type and the type may depend on the nature of the resources transferred. For example, the units may be one or more of: bytes or other measures of storage, multimedia units such as a number of songs or videos transferred, fiat units or currency units such as dollars, cryptocurrency units such as a number of bitcoin transferred, or units of other types.

The example resource consumption event management interface 1100 also includes an available resource indicator 1112 which indicates a quantum of available resources following the various resource consumption events; i.e., following the transfers. The available resource indicator 1112 may, for example, indicate a balance, which is a numerical indicator of the available resources remaining following the transfers.

In the illustrated example, the example resource consumption event management interface 1000 includes a plurality of resource consumption event indicators 1010 for a plurality of resource consumption events. In some implementations, the resource consumption event management interface 1000 may display only a single resource consumption event indicator 1010 for a single resource consumption event.

Similar to the resource consumption event management interface 800 of FIG. 8, the resource consumption event management interface 1100 of FIG. 11 may include a visual feature 1114 to indicate which of the resource consumption events are eligible for supplemental resource requests. Eligibility may be determined based on various criteria including, for example, a quantum of resources used and/or the descriptor or other metadata associated with a resource consumption event.

Transfers may, in at least some implementations, be referred to as database operations and/or database events since such transfers may be reflected in databases. Transfers may, in at least some implementations, be referred to as computing operations, since such transfers are performed by computers.

In each of the example, resource consumption event management interfaces 800, 900, 1000, 1100 of FIGS. 8-11, the resource consumption event management interface includes resource consumption event indicators 810, 910, 1010, 1110 for resource consumption events associated with a particular resource domain. The particular resource domain may be or include one or more of a particular computer system, a particular computing network, and a particular logical storage area. For example, the resource consumption events indicated on a particular one of the interfaces may be associated with a particular account.

Referring back to FIG. 5, the resource consumption event management interface 800, 900, 1000, 1100 provided at operation 502 may take various forms and the resource consumption events, such as the first resource consumption event, indicated on the resource consumption event management interface 800, 900, 1000, 1100 may be of different types. For example, in some implementations, the resource consumption events may be computing events. Such events may use, consume, transfer or temporarily occupy computing resources. For example, such events may use, consume, transfer or temporarily occupy one or more of the following types of resources: processor cycles, memory and network resources. As noted above, the resources may take other forms.

At an operation 504, the first device 108 and/or the first resource domain system 130 may detect a particular interaction at the first device 108 with a particular resource consumption event indicator 810, 910, 1010, 1110, such as the first resource consumption event indicator. In some implementations, the particular interaction may be a gesture detected via an input interface associated with the first device 108. By way of example, the gesture may be a touchscreen gesture that is detected at a touchscreen display of the first device 108. That is, the first device 108 and/or the first resource domain system may, at the operation 504, detect a touch gesture of a defined type applied to one of the resource consumption event indicators, such as a first resource consumption event indicator, which may be associated with a first resource consumption event. The gesture of the defined type may be a swipe gesture. The gesture of the defined type may be a swipe gesture in a particular direction. By way of example, the gesture of the defined type may be a lateral swipe gesture. The gesture of the defined type may be a left swipe gesture and/or a right swipe gesture. The system performing the method may only determine that the gesture of the defined type has been performed if the gesture has specific directionally properties. For example, the system may require that the gesture be a swipe that is in a particular direction, such as towards the left or right as the case may be, and that is generally parallel to a top edge and/or bottom edge of the display.

In response to detecting the gesture of the defined type, the first device 108 and/or the first resource domain system 130 may perform one or more computing operations. For example, in response to detecting the gesture of the defined type, the first device 108 and/or the first resource domain system 130 may, at an operation 506, recruit a supplemental resource. The supplemental resource may be recruited based on a resource consumed during the first resource consumption event. By recruiting the supplemental resource, the first device 108 and/or the first resource domain system 130 may make the supplemental resource available to the resource domain.

Recruiting the supplemental resource may include various operations. For example, recruiting the supplemental resource may include one or more of: releasing memory reserves, freeing up network resources using network management techniques, performing a database operation to reflect an adjustment of an amount of resources available in the resource domain, and performing a transfer of resources. The supplemental resources that are recruited may be of a same type as the resources indicated on the resource consumption event management interface 800, 900, 1000, 1100 and/or may be the same type as the resource consumption event associated with the resource consumption event indicator at which the touch gesture was received.

By way of example, in some implementations, memory resources and/or processor resources may be recruited from another system or device. By way of further example, in some implementations, supplemental resources may be recruited by initiating a transfer of resources. For example, supplemental resources may be transferred from an external logical storage area to a logical storage area that is associated with the displayed resource consumption event management interface 800, 900, 1000, 1100.

In some implementations, the operation 506 may be a multi-step operation. By way of example, in some implementations, the first device 108 and/or the first resource domain system 130 may, at the operation 506, in response to detecting the gesture of the defined type, display a prompt on the first device 108 to confirm that supplemental resources are to be recruited. Then, in response to receiving confirmation via the prompt that the supplemental resources are to be recruited, the first device 108 and/or the first resource domain system 130 may recruit the supplemental resource by, for example, making the supplemental resource available to the first device 108 and/or a system or logical storage area associated with the first device 108. This may involve, for example, initiating a transfer. The recruiting of the supplemental resource may involve performing a database operation. By way of example, the database operation may debit one logical storage area and credit another logical storage area, such as the logical storage area associated with the first device 108.

In at least some implementations, the supplemental resource may be recruited based on the resource consumed during the first resource consumption event. That is, the supplemental resource may be recruited based on the resource consumed during the resource consumption event associated with the resource consumption event indicator at which the gesture of the defined type was received. The supplemental resource may, for example, be of the same type of resource that was consumed during that resource consumption event. In some implementations, the amount of supplemental resources that are recruited may correspond to the amount of resources consumed during that resource consumption event. That is, the quantum of supplemental resources that are recruited at the operation 506 may be the same as the quantum of resources consumed during that resource consumption event. In this way, the recruitment of the supplemental resource may effectively cancel out that resource consumption event, so that the same amount of resources are available as would be if that resource consumption event did not occur and if supplemental resources were not recruited.

Additionally or alternatively, the first device 108 and/or the first resource domain system 130 may, at the operation 506, determine whether supplemental resources are available to be recruited. This may include, for example, determining whether supplemental resources exist and/or whether a logical storage area, such as an account, associated with the first device 108, is eligible to receive such supplemental resources. For example, the supplemental resources may not be made available to all logical storage areas; they may only be available to logical storage areas satisfying certain defined criteria. The first device 108 and/or the first resource domain system 130 may evaluate whether the defined criteria is satisfied before recruiting the supplemental resources. If the criteria are not satisfied, then the supplemental resources may not be recruited.

The eligibility analysis may, in some instances, be displayed prior to the gesture being performed at the operation 502. For example, the resource consumption event management interface 800, 900, 1000, 1100 provided at the operation 502 may include one or more indicators 814, 914, 1014, 1114 to indicate which of the resource consumption events are eligible to use supplemental resources to offset such events. Or, in some cases, the resource consumption event management interface 800, 900, 1000, 1100 may include a filtered listing of resource consumption events that are eligible, excluding those resource consumption events that are not eligible.

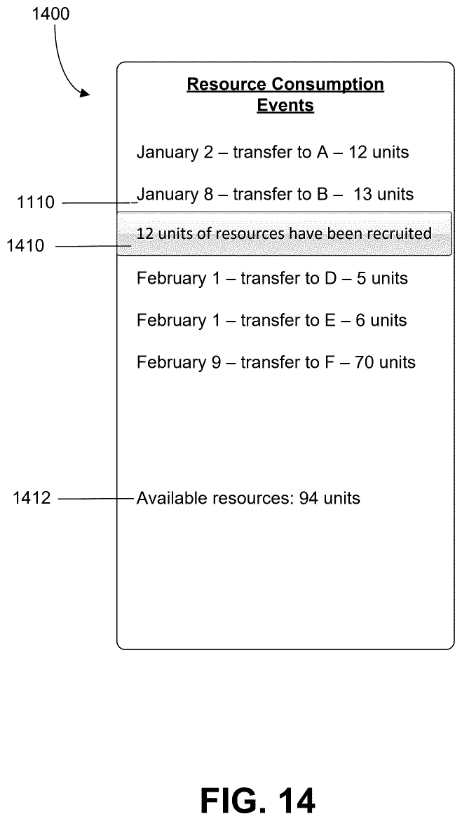

After a supplemental resource has been recruited, the first device 108 and/or the first resource domain system 130 may, at an operation 508, update the resource consumption event management interface 800, 900, 1000, 1100 to visually indicate that the supplemental resource has been recruited. For example, referring briefly to FIG. 14, an example resource consumption event management interface 1400 is illustrated. The example resource consumption event management interface 1400 of FIG. 14 is similar to the resource consumption event management interface 1100 of FIG. 11. For example, the resource consumption event management interface 1400 of FIG. 14 represents resource consumption events that are transfers. The resource consumption event management interface 1400 includes an indicator 1410 which indicates that supplemental resources have been recruited and that indicates a quantum of supplemental resources recruited. Additionally or alternatively, the resource consumption event management interface 1400 may include an updated available resource indicator 1412. The updated available resource indicator 1412 indicates an amount of resources available after the recruitment of the supplemental resources.

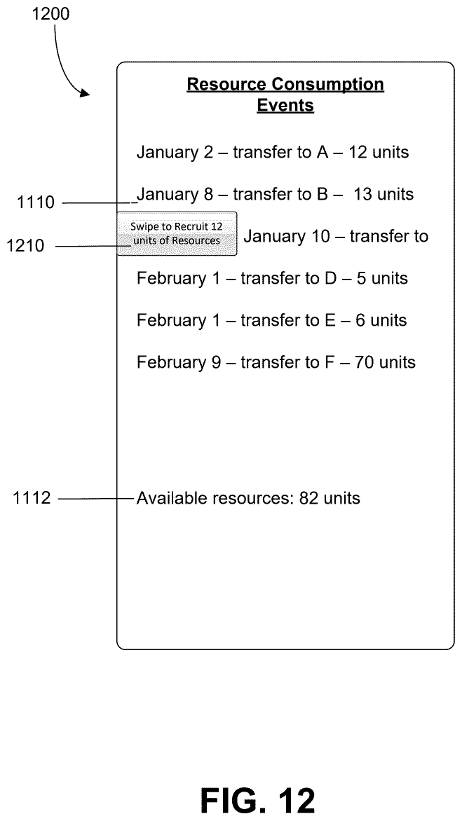

The method 500 described above may be modified. For example, referring now to FIG. 12, in one example, after a touch gesture is determined to be initiated during the operation 504, the resource consumption event management interface 1200 may be updated to include an indicator 1210 to indicate a computing operation that will be performed upon completion of the touch gesture. In this case, the indicator indicates an amount of supplemental resources that will be recruited. The indicator may also indicate the action that is to be completed by the user to cause the computing operation to be performed. For example, “swipe” is illustrated in the example. This indicator 1210 may be displayed in line with and/or adjacent to the resource consumption event indicator at which the touch gesture was initiated. As illustrated, the resource consumption event indicator involved in the touch gesture may scroll in the direction of the touch gesture to free up display resources for the indicator 1210 to be displayed.

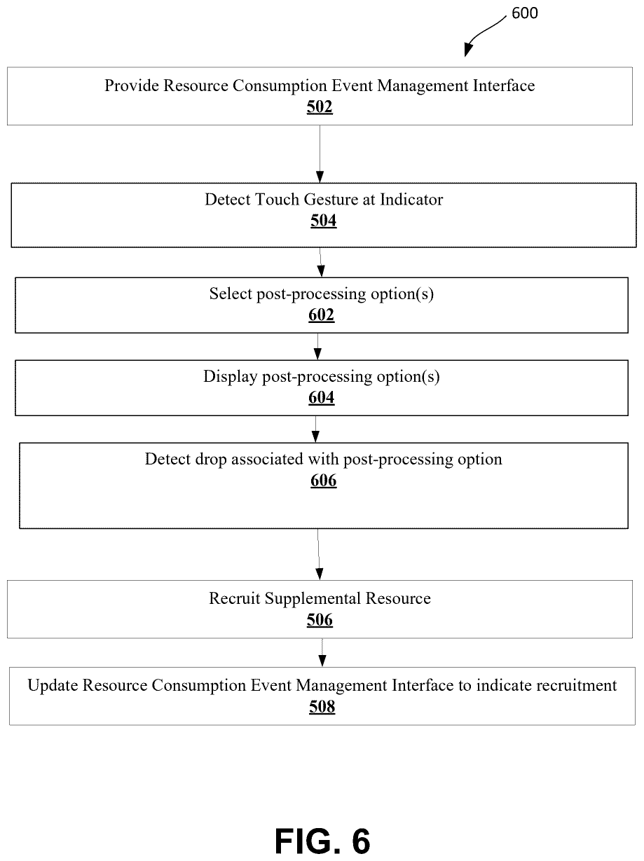

Reference is now made to FIG. 6, which shows, in flowchart form, a further example method 600 of managing resources at a resource domain. The method 600 may be implemented by a computing system such as the first resource domain system 130 and/or the first device 108 of FIG. 1. For example, a software module may be configured to cause the first resource domain system 130 and/or the first device 108 of FIG. 1 to implement the method 600. The method 600 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first resource domain system 130 to perform all or parts of the method 600 or a portion thereof.

In performing the method 600, the first resource domain system 130, or the first device 108 may cooperate with other systems and devices such as, for example, the other of the first device 108 (FIG. 1) and the first resource domain system 130. Each of these devices may be configured with processor-executable instructions which cause such devices to perform methods which cooperate with the method 600. Accordingly, operations that are referred to below as being performed by the first device 108 may be included in a method which a processor of the first device 108 may perform. Similarly, operations that are referred to below as being performed by the first resource domain system 130 may be included in a method which a processor of the first resource domain system 130 may perform. Further, in performing such a method, the first resource domain system 130 may cooperate with the first device 108. Further, at least some operations described as being performed by the first device 108 or the first resource domain system 130 may be performed by another device or system. For example, some of the operations described as being performed by the first resource domain system 130 may instead be performed by the first device 108 and vice versa.

The method 600 of FIG. 6 includes a number of operations in common with the method 500 of FIG. 5 and, for the sake of readability, the discussion of all aspects of such operations will not be repeated. The features described above with reference to the method 500 may be performed during the method 600. For example, the method 600 includes the operations 502, 504, 506, 508 of the method 500.

At the operation 502, as described above, the first resource domain system 130 and/or the first device 108 may provide the resource consumption event management interface 800, 900, 1000, 1100. The operation 502 of the method 600 of FIG. 6 may be performed in the manner described above with reference to the method 500 of FIG. 4. For example, the resource consumption event management interface 800, 900, 1000, 1100 may be of a type described above with reference to any one of FIGS. 9 to 11.

At an operation 504, the method 600 may include detecting a gesture of a defined type, such a touch gesture of a defined type applied to a particular resource consumption event indicator, with may be referred to as a first resource consumption event indicator. The operation 504 may be performed as described above with reference to FIG. 5.

The first resource domain system 130 and/or the first device 108 may, at an operation 602, select one or more post-processing action options. The post-processing action options may be selected based on metadata, such as one or more parameters of the first resource consumption event; that is, based on one or more parameters of the resource consumption event whose indicator was touched during the touch gesture. For example, the post-processing action options may be selected based on a data type associated with the first resource consumption event. The data type may be, for example, a type of resource consumed or another identifier of a resource consumed. By way of example, different data types may have different post-processing actions.

The post-processing action options may be selected based on, for example, a quantum of resources consumed in the resource consumption event. For example, one post-processing action option may be selected for a resource consumption event that used more than a threshold amount of resources and another post-processing action option may be selected for a resource consumption event that used less than the threshold amount of resources.

In at least some implementations in which the resource consumption event represents a transfer of resources, the post-processing action options may be selected based on, for example, a recipient identifier for the transfer. For example, a first post-processing action option may be selected for a resource consumption event that transferred a resource to a first destination whereas a second post-processing action option may be selected for a resource consumption event that transferred a resource to a second destination.

The post-processing option(s) may represent, for example, a restoration schedule. The restoration schedule may be a schedule for returning the supplemental resource. The post-processing option(s) may represent a timeline for a return of the supplemental resource. The post-processing option(s) may indicate whether the supplemental resource is to be returned in parts and, if so, it may indicate a size of each part.

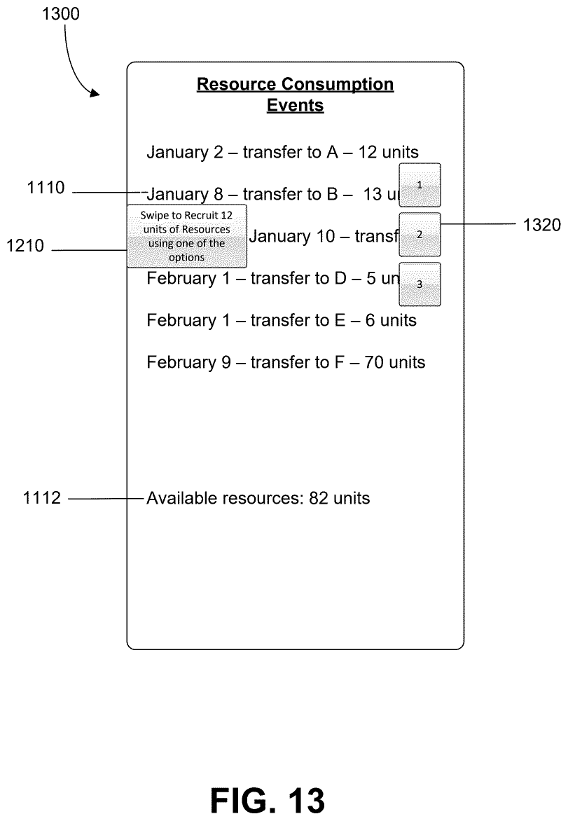

In at least some implementations, during the touch gesture, the first resource domain system 130 and/or the first device 108 may, at an operation 604, display one or more indicators associated with the one or more post-processing action options. Referring now to FIG. 13, a resource consumption event management interface 1300 is displayed. This resource consumption event management interface 1300 may be a modified version of one of the interfaces previously discussed. For example, the resource consumption event management interface 1300 may include features described above with reference to FIG. 12. Additionally, the resource consumption event management interface 1300 may include indicators 1320 associated with the one or more post-processing action options. By way of example, one of the post-processing options may represent a restoration schedule that has a longer duration than another of the post-processing options. The customer may complete the touch gesture at a particular one of the indicators 1320 to select that post-processing action option.

For example, referring again to FIG. 6, at an operation 606, the first resource domain system 130 and/or the first device may detect that the touch gesture includes a drop at one of the indicators associated with one of the post-processing action options. That is, the first resource domain system 130 and/or the first device may determine that the touch gesture ended at a particular one of the indicators, which is associated with a particular one of the post-processing action options. The first resource domain system 130 and/or the first device may then, during the operation 506, recruit the supplemental resource based on the post-processing action option associated with the one of the indicators 1320 associated with the drop. The supplemental resource may be recruited as described above with reference to FIG. 5, but the post-processing action option may be configured based on the indicator 1320 involved in the touch gesture drop. For example, a restoration schedule may be configured based on the restoration schedule for that post-processing action option.

The first resource domain system 130 and/or the first device may, at the operation 508, update the resource consumption event management interface to visually indicate that the supplemental resource has been recruited. In at least some implementations, the updating may indicate the selected post-processing action option, which was the option configured during the operation 506.

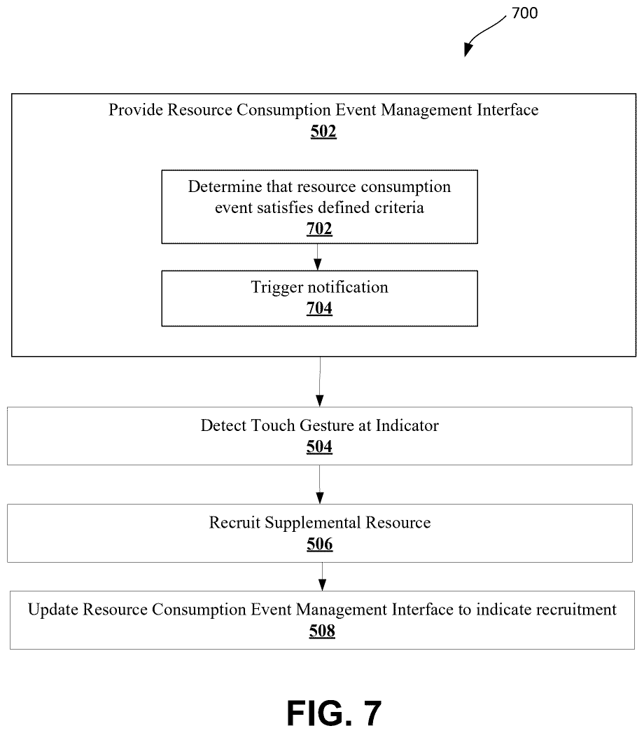

Reference is now made to FIG. 7, which shows, in flowchart form, a further example method 700 of managing resources at a resource domain. The method 700 may be implemented by a computing system such as the first resource domain system 130 and/or the first device 108 of FIG. 1. For example, a software module may be configured to cause the first resource domain system 130 and/or the first device 108 of FIG. 1 to implement the method 700. The method 700 may be performed, for example, by the processor 310 (FIG. 3) of a computer device 300 executing software comprising instructions such as may be stored in the memory 320 of the computer device 300. More particularly, processor-executable instructions may, when executed, configure a processor 310 of a computing system such as the first resource domain system 130 to perform all or parts of the method 700 or a portion thereof.

In performing the method 700, the first resource domain system 130, or the first device 108 may cooperate with other systems and devices such as, for example, the other of the first device 108 (FIG. 1) and the first resource domain system 130. Each of these devices may be configured with processor-executable instructions which cause such devices to perform methods which cooperate with the method 700. Accordingly, operations that are referred to below as being performed by the first device 108 may be included in a method which a processor of the first device 108 may perform. Similarly, operations that are referred to below as being performed by the first resource domain system 130 may be included in a method which a processor of the first resource domain system 130 may perform. Further, in performing such a method, the first resource domain system 130 may cooperate with the first device 108. Further, at least some operations described as being performed by the first device 108 or the first resource domain system 130 may be performed by another device or system. For example, some of the operations described as being performed by the first resource domain system 130 may instead be performed by the first device 108 and vice versa.

The method 700 of FIG. 6 includes a number of operations in common with the method 500 of FIGS. 5 and 6 and, for the sake of readability, the discussion of all aspects of such operations will not be repeated. The features described above with reference to the methods 500 and 600 may be performed during the method 700. For example, the method 700 includes the operations 502, 504, 506, 508 of the method 500.

The method 700 of FIG. 7 may, in at least some implementations, include operations of the method 600 of FIG. 6. At least some such operations may not be illustrated in FIG. 7.

At the operation 502, as described above, the first resource domain system 130 and/or the first device 108 may provide the resource consumption event management interface 800, 900, 1000, 1100. The operation 502 of the method 600 of FIG. 6 may be performed in the manner described above with reference to the method 500 of FIG. 4. For example, the resource consumption event management interface 800, 900, 1000, 1100 may be of a type described above with reference to any one of FIGS. 9 to 11.

The operation 502 may include further operations 702, 704. That is, the first resource domain system 130 and/or the first device 108 may perform the operations 702, 704 when providing, at the computing system associated with the resource domain, the resource consumption event management interface, at the operation 502. At the operation 702, the first resource domain system 130 and/or the first device 108 may determine that the first resource consumption event satisfies defined criteria. Then, at the operation 704, the first resource domain system 130 and/or the first device 108 may, in response to determining that the first resource consumption event satisfies the defined criteria, trigger a notification at the computing system associated with the resource domain. The notification may facilitate access to the resource consumption event management interface.

For example, at the operation 702, the first resource domain system 130 and/or the first device 108 may determine that a particular resource consumption event, such as the first resource consumption event, is eligible for recruitment of a supplemental resource. Then, if it is eligible, the notification may be sent at the operation 704. This notification may be sent to the first device 108. This notification may indicate that the resource consumption event satisfies the defined criteria. For example, it may indicate that the resource consumption event is an eligible resource consumption event, meaning it is a resource consumption event that can be offset by recruiting a supplemental resource.

In some implementations, determining that the first resource consumption event satisfies defined criteria may include determining that the first resource consumption event is an outlier event. An outlier event is a non-standard event. For example, the outlier event may be an unusual event. Put differently, the outlier event may be an event that is not predicted based on past resource consumption events. The outlier event may be a resource consumption event that is off-pattern. That is, the outlier event may be an event that falls outside a typical pattern.

In some implementations, determining that the first resource consumption event satisfies defined criteria may include determining that the first resource consumption event consumed at least a threshold amount of resources. For example, supplemental resources may only be recruited for resource consumption events that are considered sufficiently impactful and a threshold may be used to evaluate whether a particular resource consumption event is, in fact, sufficiently impactful.

Following the operation 502, the operations 504, 506 and 508 may be performed as described above with reference to FIG. 5.

In the present application, the term account or user account may be used interchangeably with “logical storage area” or “record” or “record in a database”.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system, comprising:
a processor;
a communications module coupled to the processor; and
a memory coupled to the processor, the memory storing instructions that, when executed, configure the processor to:
provide, at a computing system associated with a resource domain, a resource consumption event management interface, the resource consumption event management interface including a first resource consumption event indicator associated with a first resource consumption event at the resource domain;
detect a touch gesture of a defined type applied to the first resource consumption event indicator; and
in response to detecting the touch gesture of the defined type applied to the first resource consumption event indicator, recruit a supplemental resource, based on a resource consumed during the first resource consumption event, to make the supplemental resource available to the resource domain.

2. The computer system of claim 1, wherein the first resource consumption event is a computing event that uses, consumes, transfers or temporarily occupies one or more of the following types of resources: processor cycles, memory and network resources.

3. The computer system of claim 1, wherein recruiting the supplemental resource includes performing one or more of:
releasing memory reserves;
freeing up network resources using network management techniques;
performing a database operation to reflect an adjustment of an amount of resources available in the resource domain; and
performing a transfer of the supplemental resource.

4. The computer system of claim 1, wherein the resource domain includes one or more of a particular computer system, a particular computing network, and a particular logical storage area.

5. The computer system of claim 1, wherein the instructions further configure the processor to:
during the touch gesture, displaying indicators associated with one or more post-processing action options; and
detect that the touch gesture includes a drop at one of the indicators associated with one of the post-processing action options,
and wherein recruiting the supplemental resource incudes recruiting the supplemental resource based on the post-processing action option associated with the one of the indicators associated with the drop.

6. The computer system of claim 5, wherein the one or more post-processing action options are selected based on a data type associated with the first resource consumption event.

7. The computer system of claim 1, wherein providing, at the computing system associated with the resource domain, the resource consumption event management interface includes:
determining that the first resource consumption event satisfies defined criteria; and
in response to determining that the first resource consumption event satisfies the defined criteria, triggering a notification at the computing system associated with the resource domain, the notification facilitating access to the resource consumption event management interface.

8. The computer system of claim 7, wherein determining that the first resource consumption event satisfies defined criteria includes determining that the first resource consumption event is an outlier event.

9. The computer system of claim 7, wherein determining that the first resource consumption event satisfies defined criteria includes determining that the first resource consumption event consumed at least a threshold amount of resources.

10. The computer system of claim 1, wherein the resource consumption event management interface further includes a second resource consumption event indicator associated with a second resource consumption event at the resource domain, and wherein the resource consumption event management interface further includes a visual feature to indicate which of the first and second resource consumption events are eligible for supplemental resource requests.

11. The computer system of claim 1, wherein the instructions further configure the processor to, after recruiting the supplemental resource, update the resource consumption event management interface to visually indicate that the supplemental resource has been recruited.

12. The computer system of claim 1, wherein the touch gesture of the defined type is a lateral swipe gesture.

13. A processor-implemented method comprising:
providing, at a computing system associated with a resource domain, a resource consumption event management interface, the resource consumption event management interface including a first resource consumption event indicator associated with a first resource consumption event at the resource domain;
detecting a touch gesture of a defined type applied to the first resource consumption event indicator; and
in response to detecting the touch gesture of the defined type applied to the first resource consumption event indicator, recruiting a supplemental resource, based on a resource consumed during the first resource consumption event, to make the supplemental resource available to the resource domain.

14. The processor-implemented method of claim 13, wherein the first resource consumption event is a computing event that uses, consumes, transfers or temporarily occupies one or more of the following types of resources: processor cycles, memory and network resources.

15. The processor-implemented method of claim 13, wherein recruiting the supplemental resource includes performing one or more of:
releasing memory reserves;
freeing up network resources using network management techniques;
performing a database operation to reflect an adjustment of an amount of resources available in the resource domain; and
performing a transfer of the supplemental resource.

16. The processor-implemented method of claim 13, wherein the resource domain includes one or more of a particular computer system, a particular computing network, and a particular logical storage area.

17. The processor-implemented method of claim 13, further comprising:
during the touch gesture, displaying indicators associated with one or more post-processing action options; and
detecting that the touch gesture includes a drop at one of the indicators associated with one of the post-processing action options,
and wherein recruiting the supplemental resource incudes recruiting the supplemental resource based on the post-processing action option associated with the one of the indicators associated with the drop.

18. The processor-implemented method of claim 17, wherein the one or more post-processing action options are selected based on a data type associated with the first resource consumption event.

19. The processor-implemented method of claim 13, wherein providing, at the computing system associated with the resource domain, the resource consumption event management interface includes:
determining that the first resource consumption event satisfies defined criteria; and
in response to determining that the first resource consumption event satisfies the defined criteria, triggering a notification at the computing system associated with the resource domain, the notification facilitating access to the resource consumption event management interface.

20. The processor-implemented method of claim 19, wherein determining that the first resource consumption event satisfies defined criteria includes determining that the first resource consumption event is an outlier event.
